(19) United States
(12) Patent Application Publication
(10) Pub. No.: US 2026/0063548 A1
(43) Pub. Date: Mar. 5, 2026

(54) NOISE SUPPRESSION USING MULTIPLE LIGHT SENSORS IN A PHOTOELECTRIC SMOKE DETECTOR

(71) Applicant: Microchip Technology Incorporated, Chandler, AZ (US)

(72) Inventors: Patrick McFarland, Gilbert, AZ (US); Arthur B. Eck, Gilbert, AZ (US); Jonathan Corbett, Havertown, PA (US); Robert Perkel, Chandler, AZ (US)

(73) Assignee: Microchip Technology Incorporated, Chandler, AZ (US)

(21) Appl. No.: 18/941,100

(22) Filed: Nov. 8, 2024

Related U.S. Application Data
(60) Provisional application No. 63/690,745, filed on Sep. 4, 2024.

(51) Int. Cl. G01N 21/53

(52) U.S. Cl. CPC G01N 21/53; G01N 2201/121

(57) ABSTRACT

A system and method for the use of digital analysis to filter out extraneous light are disclosed. The system may include a light source to emit a light beam in a smoke detector. The system may include a first light sensor in the smoke detector to receive a reflected light beam corresponding to the light beam reflecting off a smoke particle. The system may include a second light sensor in the smoke detector to receive a noise light corresponding to ambient light in the smoke detector. The system may include a control circuit. The control circuit may be to receive the reflected light signal from a first light sensor indicative of the reflected light beam and to receive a noise signal from the second light sensor indicative of the noise light. The control circuit may be to reduce noise from the reflected light signal based on the noise signal.

### PRIORITY

This application claims priority to U.S. Provisional Ser. No. 63/690,745 filed Sep. 4, 2024, the contents of which are hereby incorporated in their entirety.

### TECHNICAL FIELD

The present disclosure relates to photoelectric smoke detectors and, in particular, to noise suppression using multiple light sensors in a photoelectric smoke detector.

### BACKGROUND

A photoelectric smoke detector uses non-polarized light to detect smoke particles. Photoelectric smoke detectors may include a chamber or may be chamberless (also referred to as “open room detectors”). A light source in the smoke detector emits a small light beam. The light beam may be emitted at a fixed level or in adjustable step levels. When smoke particles are present, the smoke particles scatter the light beam. A light sensor in the smoke detector detects the scattered light to allow an alarm to be triggered. The light source and light sensor may be positioned off angle such that when smoke is present, the smoke reflects the light and causes the receiver to receive the reflected light. Extraneous ambient light (e.g., from the sun or lighting in a room) may be difficult to distinguish from the transmitted light pulse, especially if the photoelectric smoke detector is an open room detector.

Underwriters Laboratories (UL) establishes standards for product safety. UL standards for smoke detectors establish requirements for, for example, sensitivity and reliability. UL standards require that smoke detectors have less sensitivity to cooking fires and more sensitivity to smoldering fires. These standards have resulted in the tripping point of a smoke detector moving closer to the noise floor, causing light leakage into the chamber to be a greater problem.

### SUMMARY OF THE INVENTION

Aspects provide systems and methods for noise suppression using multiple light sensors in a photoelectric smoke detector. Examples of the present disclosure may include an apparatus. The apparatus may include a first light sensor interface communicatively coupled to a first light sensor in a smoke detector. The apparatus may additionally include a second light sensor interface communicatively coupled to a second light sensor in the smoke detector. The apparatus may further include a control circuit communicatively coupled to the first light sensor interface and the second light sensor interface. The control circuit may be to receive a reflected light signal from the first light sensor via the first light sensor interface. The control circuit may also be to receive a noise signal from the second light sensor via the second light sensor interface. The control circuit may further be to reduce noise from the reflected light signal based on the noise signal.

In combination with any of the above examples, the control circuit may be to reduce the noise from the reflected light signal by subtracting the noise signal from the reflected light signal.

In combination with any of the above examples, the second light sensor may be substantially aligned with a source of the noise signal.

In combination with any of the above examples, the second light sensor may be positioned such that the reflected light signal is outside a field of view of the second light sensor.

In combination with any of the above examples, the first light sensor and the second light sensor may be substantially aligned.

In combination with any of the above examples, the control circuit may be to process the noise signal using at least one of a Weiner filter or a Kalman filter to improve a signal-to-noise ratio of the noise signal.

In combination with any of the above examples, the control circuit may be to integrate the noise signal over time to increase a signal-to-noise ratio of the noise signal.

Alone or in combination with any of the above examples, examples of the present disclosure may include a method. The method may include receiving a reflected light signal from a first light sensor in a smoke detector. The method may additionally include receiving a noise signal from a second light sensor in the smoke detector. The method may further include reducing noise from the reflected light signal based on the noise signal.

In combination with any of the above examples, the method may include reducing the noise from the reflected light signal includes subtracting the noise signal from the reflected light signal.

In combination with any of the above examples, the second light sensor may be substantially aligned with a source of the noise signal.

In combination with any of the above examples, the second light sensor may be positioned such that the reflected light signal is outside a field of view of the second light sensor.

In combination with any of the above examples, the first light sensor and the second light sensor may be substantially aligned.

In combination with any of the above examples, the method may include processing the noise signal using at least one of a Weiner filter or a Kalman filter to improve a signal-to-noise ratio of the noise signal.

Alone or in combination with any of the above examples, examples of the present disclosure may include a system. The system may include a light source to emit a light beam in a smoke detector. The system may also include a first light sensor in the smoke detector to receive a reflected light beam corresponding to the light beam reflecting off a smoke particle. The system may additionally include a second light sensor in the smoke detector to receive a noise light corresponding to ambient light in the smoke detector. The system may further include a control circuit. The control circuit may be to receive a reflected light signal from the first light sensor indicative of the reflected light beam. The control circuit may additionally be to receive a noise signal from the second light sensor indicative of the noise light. The control circuit may further be to reduce noise from the reflected light signal based on the noise signal.

In combination with any of the above examples, the control circuit may be to reduce noise from the reflected light signal by subtracting the noise signal from the reflected light signal.

In combination with any of the above examples, the second light sensor may be substantially aligned with a source of the noise signal.

In combination with any of the above examples, the second light sensor may be positioned such that the reflected light signal is outside a field of view of the second light sensor.

In combination with any of the above examples, the first light sensor and the second light sensor may be substantially aligned.

In combination with any of the above examples, the control circuit may be to process the noise signal using at least one of a Weiner filter or a Kalman filter to improve a signal-to-noise ratio of the noise signal.

In combination with any of the above examples, the control circuit may be to integrate the noise signal over time to increase a signal-to-noise ratio of the noise signal.

### BRIEF DESCRIPTION OF THE DRAWINGS

The figures illustrate examples of systems and methods for noise suppression using multiple light sensors in a photoelectric smoke detector.

FIG. 1 illustrates a system for noise suppression using multiple light sensors in a photoelectric smoke detector, according to examples of the present disclosure;

FIG. 2 illustrates a block diagram of an apparatus for noise suppression using multiple light sensors in a photoelectric smoke detector, according to examples of the present disclosure;

FIG. 3 illustrates a block diagram of a system for noise suppression using multiple light sensors in a photoelectric smoke detector, according to examples of the present disclosure;

FIG. 4 illustrates a method performed for the use of digital analysis to filter out extraneous light, according to examples of the present disclosure; and

FIG. 5 illustrates a more detailed method performed for the use of digital analysis to filter out extraneous light, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for noise suppression using multiple light sensors in a photoelectric smoke detector are provided. Using the disclosed system and method, a light sensor may be used to measure noise or interference light. Once the noise light is identified, it may be filtered out. For example, the signal from light causing noise in the signals analyzed in the photoelectric smoke detector may be identified and removed from a reflected light signal from a light sensor.

The disclosed system and method may result in a photoelectric smoke detector with improved performance against noise while having a lower cost of energy usage. The disclosed system and method may enable the capability of using chamberless photoelectric smoke detectors, eliminating the cost of the chamber and maintenance associated with the chamber (e.g., dust buildup). The disclosed system and method may be used to determine a light environment surrounding the photoelectric smoke detector. Artificial intelligence may be used to predict issues with the photoelectric smoke detector and the artificial intelligence may be trained using data from the light sensors in the photoelectric smoke detector.

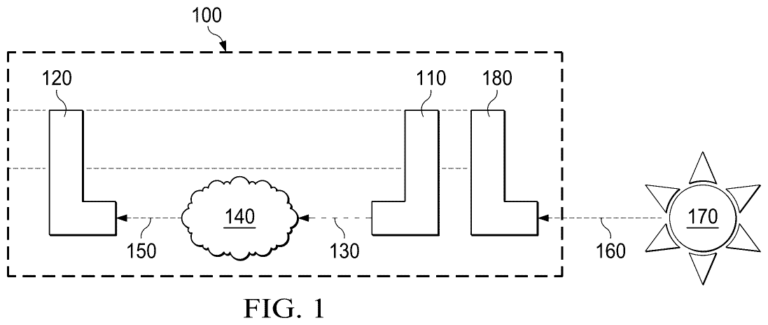

FIG. 1 illustrates a system for noise suppression using multiple light sensors in a photoelectric smoke detector, according to examples of the present disclosure. Photoelectric smoke detector 100 may include light source 110 and light sensor 120.

Light source 110 may emit light beam 130. Light source 110 may be any suitable type of light source, such as, but not limited to, a light emitting diode (LED), a vertical cavity surface emitting laser, or an incandescent light bulb. Light beam 130 may be formed of infrared, visible, or ultraviolet light. When smoke is present, light beam 130 may reflect off smoke particles 140, resulting in reflected light beam 150. Reflected light beam 150 may be received by light sensor 120. Light sensor 120 may be any suitable type of light sensor, such as, but not limited to, a photodiode or a phototransistor. In some examples, light sensor 120 may include multiple light sensors. When reflected light beam 150 is received by light sensor 120, light sensor 120 may generate an electrical signal that may be analyzed to determine when to sound a fire alarm.

Light sensor 120 may also receive noise light 160. Noise light 160 may be caused extraneous light (e.g., light not corresponding to light beam 130). For example, noise light 160 may be created by noise source 170. Noise source 170 may be, for example, a natural light source (e.g., the sun, the moon) or an artificial light source (e.g., a light bulb, television, electronic device). As another example, in examples where the photoelectric smoke detector includes a chamber surrounding light source 110, light sensor 120, and noise light sensor 180, the chamber may include baffles along the outer perimeter of the chamber. The baffles may allow smoke to enter the chamber and may reduce the amount of ambient light entering the chamber. When ambient light enters the chamber (referred to as “baffle reflection leakage light”), the ambient light may be detected by light sensor 120, causing the photoelectric smoke detector to incorrectly identify the presence of smoke particles. At least a portion of the noise signal may be indicative of the baffle reflection leakage light. The noise signal may also be caused by line noise. For example, light generated by electricity provided by power lines may contain oscillations at the frequency at which the electricity is provided (e.g., 50 Hertz (Hz) in the European Union and 60 Hz in the United States). Light noise 160 may also be received by noise light sensor 180. In some examples, after light noise 160 is received by noise light sensor 180, a signal indicative of noise light 160 may be processed using a filter, such as, but not limited to, a Weiner or Kalman filter.

Noise light sensor 180 may be positioned within photoelectric smoke detector 100 such that noise light sensor 180 does not receive light beam 130, reflected light beam 150, or any combination thereof. For example, noise light sensor 180 may be positioned as close to light source 110 as possible such that light beam 130, reflected light beam 150, or any combination thereof may be outside the view of noise light sensor 180. By positioning noise light sensor 180 in this manner, light received by noise light sensor 180 may be noise light 160 and not include other light within photoelectric smoke detector 100.

In some examples of photoelectric smoke detector 100, light sensor 120 and noise light sensor 180 may be positioned such that light sensor 120 and noise light sensor 180 are substantially aligned in parallel. By aligning light sensor 120 and noise light sensor 180 in parallel, light sensor 120 and noise light sensor 180 may detect the same noise light 160. Therefore, a noise light signal from noise light sensor 180 (e.g., indicative of noise light 160) may be subtracted or removed from a signal from light sensor 120 (e.g., indicative of reflected light beam 150 and noise light 160), resulting in a reduction of the noise in the reflected light signal, increasing the signal to noise ratio of the reflected light signal.

In some examples of photoelectric smoke detector 100, noise light sensor 180 may be substantially aligned with noise source 170 such that noise light sensor 180 has an unobstructed view of noise source 170.

In some examples, the signal from light sensor 120 (e.g., indicative of indicative of reflected light beam 150 and noise light 160) may be integrated over time to improve the signal-to-noise ratio of the signal. Similarly, the signal from noise light sensor 180 (e.g., indicative of noise light 160) may be integrated over time to improve the signal-to-noise ratio of the signal.

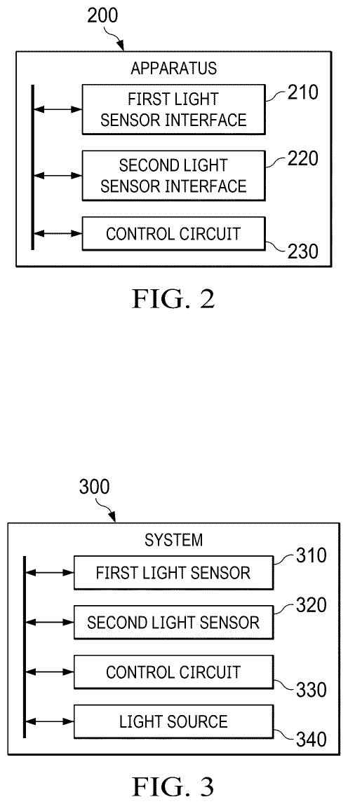

FIG. 2 illustrates a block diagram of an apparatus for noise suppression using multiple light sensors in a photoelectric smoke detector, according to examples of the present disclosure. Apparatus 200 may include first light sensor interface 210 and second light sensor interface 220 communicatively coupled to control circuit 230.

First light sensor interface 210 may allow control circuit 230 to send and receive signals from a light sensor, such as light sensor 120 shown in FIG. 1. For example, control circuit 230 may receive a reflected light signal from the light sensor via first light sensor interface 210.

Second light sensor interface 220 may allow control circuit 230 to send and receive signals from a noise light sensor, such as noise light sensor 180 shown in FIG. 1. For example, control circuit 230 may receive a noise light signal from the noise light sensor via second light sensor interface 220.

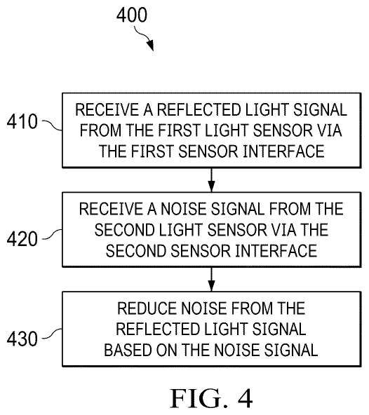

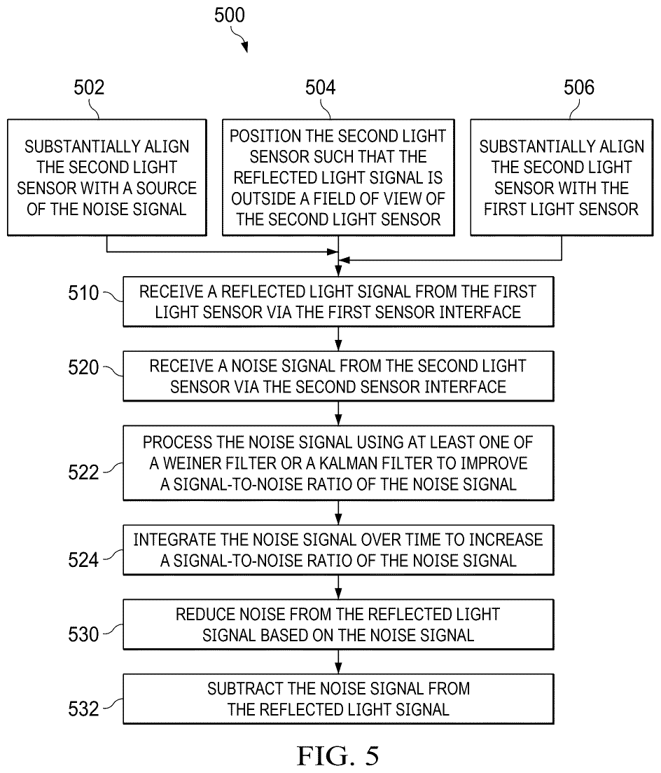

Control circuit 230 may include a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA), or other programmable logic device, discrete gate or transistor logic, discrete hardware components, other programmable device, or any combination thereof designed to perform the functions disclosed herein, in combination with a processor, or any other system operable to implement a method for noise suppression using multiple light sensors in a photoelectric smoke detector. The operations of control circuit 230 are described in further detail with respect to FIGS. 4 and 5.

FIG. 3 illustrates a block diagram of a system for noise suppression using multiple light sensors in a photoelectric smoke detector, according to examples of the present disclosure. System 300 may include first light sensor 310, second light sensor 320, and light source 340 communicatively coupled to control circuit 330.

First light sensor 310 may receive a reflected light signal and communicate the reflected light signal to control circuit 330. First light sensor 310 may be similar to light sensor 120 shown in FIG. 1.

Second light sensor 320 may receive a noise light signal and communicate the noise light signal to control circuit 330. Second light sensor 320 may be similar to noise light sensor 180 shown in FIG. 1.

Control circuit 330 may include a CPU, a general purpose processor, a specific purpose processor, a microcontroller, a PLC, a DSP, an ASIC, an FPGA, or other programmable logic device, discrete gate or transistor logic, discrete hardware components, other programmable device, or any combination thereof designed to perform the functions disclosed herein, in combination with a processor, or any other system operable to implement a method for noise suppression using multiple light sensors in a photoelectric smoke detector. The operations of control circuit 330 are described in further detail with respect to FIGS. 4 and 5.

Light source 340 may emit a light beam. Light source 340 may be similar to light source 110 shown in FIG. 1. Light source 340 may emit the light beam in response to signals received directly or indirectly from control circuit 330.

FIG. 4 illustrates a method performed for the use of digital analysis to filter out extraneous light, according to examples of the present disclosure. Method 400 may be implemented using a control circuit such as a CPU, a general purpose processor, a specific purpose processor, a microcontroller, a PLC, a DSP, an ASIC, an FPGA, or other programmable logic device, discrete gate or transistor logic, discrete hardware components, other programmable device, or any combination thereof designed to perform the functions disclosed herein, in combination with a processor, or any other system operable to implement method 400. For example, method 400 may be implemented using control circuit 230 or 330 shown in FIGS. 2 and 3, respectively. Although examples have been described above, other variations and examples may be made from this disclosure without departing from the spirit and scope of these disclosed examples.

Method 400 may begin at block 410 where the control circuit may receive a reflected light signal from the first light sensor via the first light sensor interface. The reflected light signal may include a signal indicative of a reflection of a light beam emitted by a light source (e.g., reflected light beam 150 shown in FIG. 1) and a signal indicative of a noise light (e.g., noise light 160 shown in FIG. 1). The noise light may be caused by extraneous light (e.g., the baffle reflection leakage light in a chambered photoelectric smoke detector or the ambient light in a chamberless photoelectric smoke detector), line noise, or any combination thereof.

At block 420, the control circuit may receive a noise signal from the second light sensor via the second light sensor interface. The noise signal may be a signal indicative of a noise light (e.g., noise light 160 shown in FIG. 1). The noise light may be caused by extraneous light (e.g., the baffle reflection leakage light in a chambered photoelectric smoke detector or the ambient light in a chamberless photoelectric smoke detector), line noise, or any combination thereof.

At block 430, the control circuit may reduce noise from the reflected light signal based on the noise signal. The control circuit may reduce noise from the reflected light signal (received at block 410) by removing the noise signal (received at block 420) from the reflected light signal. For example, if the reflected light signal received at block 410 is 100+10 sine (X) and the noise signal received at block 420 is 100, the remaining signal is 10 sine (X). The remaining signal may be indicative of the reflection of the light beam emitted by a light source.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

FIG. 5 illustrates a more detailed method performed for the use of digital analysis to filter out extraneous light, according to examples of the present disclosure. Method 500 may be implemented using a control circuit, such as a CPU, a general purpose processor, a specific purpose processor, a microcontroller, a PLC, a DSP, an ASIC, an FPGA, or other programmable logic device, discrete gate or transistor logic, discrete hardware components, other programmable device, or any combination thereof designed to perform the functions disclosed herein, in combination with a processor, or any other system operable to implement method 500. For example, method 500 may be implemented using control circuit 230 or 330 shown in FIGS. 2 and 3, respectively. Although examples have been described above, other variations and examples may be made from this disclosure without departing from the spirit and scope of these disclosed examples.

Method 500 may begin at block 502 where the second light sensor may be substantially aligned with a source of the noise signal. By aligning the second light sensor with the source of the noise signal, the second light sensor may have an unobstructed view of the noise source.

At block 504, the second light sensor may be positioned such that the reflected light signal is outside a field of view of the second light sensor. Therefore, the second light sensor may not receive a light beam emitted by a light source or a reflected light beam reflected by a smoke particle. By positioning the second light sensor in this manner, light received by the second light sensor may be noise light and not include other light within the photoelectric smoke detector.

At block 506, the second light sensor may be substantially aligned in parallel with the first light sensor. By aligning the first light sensor and the second light sensor in parallel, the first light sensor and the second light sensor may detect the same noise light. Therefore, a noise light signal from the second light sensor (e.g., indicative of the noise light) may be subtracted or removed from a signal from the first light sensor (e.g., indicative of the reflected light signal), resulting in a reduction of the noise in the reflected light signal, increasing the signal to noise ratio of the reflected light signal.

At block 510, the control circuit may receive a reflected light signal from the first light sensor via the first light sensor interface. The reflected light signal may include a signal indicative of a reflection of a light beam emitted by a light source (e.g., reflected light beam 150 shown in FIG. 1) and a signal indicative of a noise light (e.g., noise light 160 shown in FIG. 1). The noise light may be caused by extraneous light (e.g., the baffle reflection leakage light in a chambered photoelectric smoke detector or the ambient light in a chamberless photoelectric smoke detector), line noise, or any combination thereof.

At block 520, the control circuit may receive a noise signal from the second light sensor via the second light sensor interface. The noise signal may be a signal indicative of a noise light (e.g., noise light 160 shown in FIG. 1). The noise light may be caused by extraneous light (e.g., the baffle reflection leakage light in a chambered photoelectric smoke detector or the ambient light in a chamberless photoelectric smoke detector), line noise, or any combination thereof.

At block 522, the control circuit may process the noise signal using at least one of a Weiner filter or a Kalman filter to improve a signal-to-noise ratio of the noise signal.

At block 524, the control circuit may integrate the noise signal over time to increase a signal-to-noise ratio of the noise signal. Additionally, the control circuit may integrate the signal from the light sensor that is indicative of indicative of the reflected light beam and the noise light to improve the signal-to-noise ratio of the signal.

At block 530, the control circuit may reduce noise from the reflected light signal based on the noise signal. The control circuit may reduce noise from the reflected light signal (received at block 510) by removing the noise signal (received at block 520) from the reflected light signal. The remaining signal may be indicative of the reflection of the light beam emitted by a light source.

At block 532, the control circuit may reduce noise from the reflected light signal based on the noise signal by subtracting the noise signal from the reflected light signal. Subtracting the noise signal from the reflected light signal may result in a reduction of the noise in the reflected light signal and increase the signal to noise ratio of the reflected light signal.

Although FIG. 5 discloses a particular number of operations related to method 500, method 500 may be executed with greater or fewer operations than those depicted in FIG. 5 In addition, although FIG. 5 discloses a certain order of operations to be taken with respect to method 500, the operations comprising method 400 may be completed in any suitable order.

Although examples have been described above, other variations and examples may be made from this disclosure without departing from the spirit and scope of these disclosed examples.

1. An apparatus, comprising:
a first light sensor interface communicatively coupled to a first light sensor in a smoke detector;
a second light sensor interface communicatively coupled to a second light sensor in the smoke detector;
a control circuit communicatively coupled to the first light sensor interface and the second light sensor interface, the control circuit to:
receive a reflected light signal from the first light sensor via the first light sensor interface;
receive a noise signal from the second light sensor via the second light sensor interface; and
reduce noise from the reflected light signal based on the noise signal.

2. The apparatus of claim 1, wherein the control circuit is to reduce the noise from the reflected light signal by subtracting the noise signal from the reflected light signal.

3. The apparatus of claim 1, wherein the second light sensor is substantially aligned with a source of the noise signal.

4. The apparatus of claim 1, wherein the second light sensor is positioned such that the reflected light signal is outside a field of view of the second light sensor.

5. The apparatus of claim 1, wherein the first light sensor and the second light sensor are substantially aligned.

6. The apparatus of claim 1, wherein the control circuit is to process the noise signal using at least one of a Weiner filter or a Kalman filter to improve a signal-to-noise ratio of the noise signal.

7. The apparatus of claim 1, wherein the control circuit is to integrate the noise signal over time to increase a signal-to-noise ratio of the noise signal.

8. A method, comprising:
receiving a reflected light signal from a first light sensor in a smoke detector;
receiving a noise signal from a second light sensor in the smoke detector; and
reducing noise from the reflected light signal based on the noise signal.

9. The method of claim 8, wherein reducing the noise from the reflected light signal includes subtracting the noise signal from the reflected light signal.

10. The method of claim 8, wherein the second light sensor is substantially aligned with a source of the noise signal.

11. The method of claim 8, wherein the second light sensor is positioned such that the reflected light signal is outside a field of view of the second light sensor.

12. The method of claim 8, wherein the first light sensor and the second light sensor are substantially aligned.

13. The method of claim 8, comprising processing the noise signal using at least one of a Weiner filter or a Kalman filter to improve a signal-to-noise ratio of the noise signal.

14. A system, comprising:
a light source to emit a light beam in a smoke detector;
a first light sensor in the smoke detector to receive a reflected light beam corresponding to the light beam reflecting off a smoke particle;
a second light sensor in the smoke detector to receive a noise light corresponding to ambient light in the smoke detector; and
a control circuit to:
receive a reflected light signal from the first light sensor indicative of the reflected light beam;
receive a noise signal from the second light sensor indicative of the noise light; and
reduce noise from the reflected light signal based on the noise signal.

15. The system of claim 14, wherein the control circuit is to reduce noise from the reflected light signal by subtracting the noise signal from the reflected light signal.

16. The system of claim 14, wherein the second light sensor is substantially aligned with a source of the noise signal.

17. The system of claim 14, wherein the second light sensor is positioned such that the reflected light signal is outside a field of view of the second light sensor.

18. The system of claim 14, wherein the first light sensor and the second light sensor are substantially aligned.

19. The system of claim 14, wherein the control circuit is to process the noise signal using at least one of a Weiner filter or a Kalman filter to improve a signal-to-noise ratio of the noise signal.

20. The system of claim 14, wherein the control circuit is to integrate the noise signal over time to increase a signal-to-noise ratio of the noise signal.
